(19) United States
(12) Patent Application Publication
(10) Pub. No.: US 2023/0035835 A1
(43) Pub. Date: Feb. 2, 2023

(54) SYSTEM AND METHOD OF A MODULAR FRAMEWORK FOR CONFIGURATION AND REUSE OF WEB COMPONENTS

(71) Applicant: Spark. Orange, LLC, Syracuse, NY (US)

(72) Inventor: Edward M. Montalbano, Rochester, NY (US)

(21) Appl. No.: 17/815,659

(22) Filed: Jul. 28, 2022

Related U.S. Application Data
(60) Provisional application No. 63/203,730, filed on Jul. 29, 2021.

(51) Int. Cl. G06F 9/451; G06F 8/38; G06F 16/21; G06F 16/245

(52) U.S. Cl. CPC G06F 9/451; G06F 8/38; G06F 16/211; G06F 16/245

(57) ABSTRACT

A method for passing a View-Model from a backend system to a frontend system, includes: providing a schema that includes information for building one or more queries; verifying a user access against requested queries; acquiring data from the requested queries; and processing data of a plurality of returned records. A system for standardizing how data is received and processed by a component, a method for passing a View-Model from a backend system to a frontend system, and a method for storing changes to database records are also described.

### CROSS-REFERENCE TO RELATED APPLICATIONS

This application claims priority to and the benefit of co-pending U.S. provisional patent application Ser. No. 63/203,730, SYSTEM AND METHOD OF A MODULAR FRAMEWORK FOR CONFIGURATION AND REUSE OF WEB COMPONENTS, filed Jul. 29, 2021, which application is incorporated herein by reference in its entirety.

### FIELD OF THE APPLICATION

The application relates to a modular framework particularly to a modular framework for the configuration and reuse of web components.

### BACKGROUND

When customizing Platform-as-a-Service systems, multiple similar systems often have similar customization needs. There are often existing web component frameworks. These frameworks enable developers to take the data from the database, display the data to end users, and allow end users to interact with the data. Although different systems on the same platform are similar, the database tables and columns are rarely similar enough to allow custom software to be reused between systems without reworking the software.

### SUMMARY

A method for passing a View-Model from a backend system to a frontend system, includes: providing a schema that includes information for building one or more queries; verifying a user access against requested queries; acquiring data from the requested queries; and processing data of a plurality of returned records.

The schema can be referenced by a shorthand name loaded into a record retrieval data pipeline. A parameterized query can include subqueries and the record retrieval data pipeline can optimize the queries to run, and the processing data includes reparenting a plurality of results of the subqueries. The schema can include multiple queries that are run during the step of acquiring the data.

A system for standardizing how data is received and processed by a component includes a decouple components process to decouple from database specifications, a define repeatable transformations on data models process, a dynamic inject code process to dynamically inject code into the component, and a repeat user interface process to repeat behaviors across the system.

The component can be independent of database specifications and can be coupled to database records through a schema or equivalent data structure.

The schema or an equivalent data structure can define parameters of a data transformation which causes repeatable transformations to occur on specified columns of a View Model.

A component load code from a library can execute a self-modifying code.

The system can further include an automatic display of messages that appear in the View Model on a user display.

A method for passing a View-Model from a backend system to a frontend system, includes: providing a schema that includes information to build one or more queries; verifying a user access against requested queries; acquiring data from the requested queries; processing data of a plurality of returned records; and wherein a data pipeline in web components includes the steps of: loading schema data about the web components; acquiring the data from a backend server; and processing retrieved data.

The method can further include a system for standardizing how the data is received and processed by a component including: a decouple components process to decouple from database specifications; a define repeatable transformations on data models process; a dynamic inject code process to dynamically inject code into the component; and a repeat user interface process to repeat behaviors across the system.

The method can further include transforming the data that comes in from the backend server. The method can further include transforming the data in the View-Model before sending it to the backend server.

The method can further include running extendable methods before and after each process.

The method can further include a system to append code to the extendable methods.

The method can further include the step of defining and executing code of related, dependent, or child components to append a code to the extendable methods.

A method for storing changes to database records includes: generating a View-Model sent to a component; performing component process transformations of the database records in the View-Model; sending the View-Model from the component into a backend server; and recording the backend server records data to a database.

Information about operations attempted by the backend server can be stored in the View-Model.

The method can further include the steps of: providing a schema that includes information to build one or more queries; verifying a user access against requested queries; acquiring data from the requested queries; and processing the data to synchronize the data in the View-Model with the database.

A method for building components includes: networking layers to communicate with a backend server; generating standardization layers including: decoupling components from database specifications; defining repeatable transformations on data models; dynamically injecting code into a component; repeating user interface behaviors across a system; and generating presentation layers such that a View-Model data returned from the backend server is transformed to be presentable in the component.

The method can further include the steps of an event lifecycle: providing developers with options to configure and customize a standard behavior of a component; providing related components access to events that occur within the component; and streamlining a creation of custom components.

A system for building relational queries includes a column selection process with expanding relationships, and a filter creation process with a visual illustration of a plurality of logical groups of filter criteria.

The system can further include a data displayed alongside a column name.

The system can further include a user experience of click an “AND” and “OR” button to create new filter criteria.

The system can further include a criteria added to a new group when a pressed button is opposite from a current group's logical operation.

A method for building components includes: providing a schema that defines a data a component will retrieve from a backend server; generating event life cycles capable of self-modification; and creating an ability to load inner components through data in the schema.

The method can further include the step of configuring components with component settings and a configuration of a record retrieval query.

An outer component can display multiple inner components and an inner component configuration is defined by the schema.

The method can further include using complementary components to configure components.

The method can further include setting up the component via configuration and a code exporting process of a configured component.

The method can further include selecting at last one section of code to export.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 is a drawing showing an exemplary data pipeline to build a View-Model;

FIG. 2 is a drawing showing an exemplary web component which uses latitude and longitude coordinates to draw markers on a map;

FIG. 3 is a drawing showing an exemplary organization of a web component;

FIG. 4 is a drawing showing an exemplary standardized web component and backend server;

FIG. 5 is a drawing showing an exemplary event lifecycle;

FIG. 6 is a drawing showing an exemplary schema of a web component;

FIG. 7 is a drawing showing how a component can load an inner component;

FIG. 8 is a drawing illustrating an exemplary application for building components;

FIG. 9 is a drawing showing an exemplary Table Component and a console component that can configure it;

FIG. 10 is a drawing showing an exemplary query builder;

FIG. 11 is a drawing showing an exemplary column selection tool;

FIG. 12 is a drawing showing an exemplary filtering criteria;

FIG. 13 is a flow chart showing steps of an exemplary user experience;

FIG. 14 is a drawing showing exemplary modules and dependencies of a configured component; and

FIG. 15 is a drawing showing an exemplary server and client suitable to run a system and method of a modular framework for configuration and reuse of web components according the Application.

### DETAILED DESCRIPTION

When customizing Platform-as-a-Service systems, multiple similar systems often have similar customization needs. On systems like Salesforce™, there are often existing web component frameworks. These frameworks enable developers to take the data from the database, display the data to end users, and allow end users to interact with the data. Although different systems on the same platform are similar, the database tables and columns are rarely similar enough to allow custom software to be reused between systems without reworking the software.

When developing customizations to a system, developers can want to define systematic ways in which data, interactivity, and a consistent user experience are delivered to the end user. To do this, the developer must decouple the data sources from the web components being built. The frameworks provided by these systems make the process of decoupling data sources from a web component difficult.

Several simple methods have been developed to allow a system administrator to add pre-built web components to a page and configure the component. The process of configuring these pre-built components is often unintuitive, the scope of what can be configured is limited, and the components are often unable to support complex database relationships. As a result, custom web components can need to be built to work around the pre-built component limitations. The custom web components have a high initial development cost and increase the system's maintenance cost and complexity.

The process of developing pre-built web components to distribute between systems has limitations with regards to how customization can be achieved. The web forms that capture a system administrator's configurations are limited in how they can be customized Components that allow a system administrator to define the data that will be coupled to a pre-build component can require special knowledge of a querying language to make customizations. Pre-build components subject to these limitations will be unable to support a wide degree of customization and can have technical barriers preventing system administrators from properly configuring the component. Furthermore, components that have been configured by system administrators but do not fully meet the business requirements cannot be used as a starting point to create new components that fully meet set business requirements.

The data displayed in web components is often retrieved from a relational database. Relational databases enable a system to define how physical data is organized and how parts of the data are related. Defining how data is displayed in a web component, whether through configuration or development, requires a person to be familiar with the names of data tables and columns. Stopping to look up the names of tables and columns adds time and complexity to this process. The time it takes to look up these tables and columns is increased when trying to retrieve data that is related to other data. For example, a database can have employees that are related to different companies. Those companies can be related to different industries. To get the industry subcategory for a given employee's company, a user can have to first look up the name of the company row on the employee table, the name of the industry row on the company table, and the name of the subcategory row on the industry field.

Many aspects of the process of building custom components can be streamlined to allow for faster development. Many component frameworks today require the developer to repeatedly program many of the same general processes to get a component working. One example is programming record retrieval in the backend server and then interface with the record retrieval code from the frontend component. Another is programming record creation or updates in the backend server and then formatting data to be sent in from the frontend component.

In one general respect, an example includes a method for providing a system configured to assist in building reusable web components. The method can include developing a backend system for translating an incoming configuration message (“schema”) into a View-Model, developing a backend system for interpreting configuration data in order to retrieve data, developing extendable interfaces for standardizing all communication with the backend system, defining an event lifecycle that can be extended by web components, defining techniques for building within this web framework, developing interfaces for configuring components, developing interfaces for configuring data requests, developing web components for supporting the modularity of a system and allowing web developers to extend the functionality of a pre-built component.

### Definitions

Backend—As used herein, backend refers to a server configured to receive and respond to requests.

View-Model refers to a data structure that contains any suitable combination of business logic, data, presentation logic and the properties of the data.

Schema refers to data that communicates a plan for building the View-Model and component.

In this method, communication with the backend system can be done through a schema. The schema can contain one or more requests for specific sets of data. The schema can also contain sets of data from previous requests or newly defined data from the end user. The schema sent into the backend can cause the server to create, retrieve, update or delete data. This method can be used to generate a View-Model that contains all of the data needed by a web component. The View-Model sent by the backend to the web component can be stored in the end user's browser memory. When the end user interacts with the web component, the View-Model in the end user's browser memory can be modified and sent to the backend. These described methods enable developers to use a systematic approach to creating, retrieving, updating and deleting data. Web components built using this method can all use schemas that are structured identically.

A View-Model can contain informative messages intended for the end user. The View-Model can systematically structure the way these messages are sent.

In this method, the backend can interpret the received schema to build one or more queries of the database. The schema can define relationships between queries to run. For example, a database can have companies which each have many employees. A schema can define a query that retrieves a subset of those companies. The schema can also request a subset of only the employees that belong to those companies. This method can run related queries in a way that minimizes the number of queries to run and structures the data so that data is grouped underneath data it is related to.

This method can use extendable interfaces to standardize communication between web components and the backend. View-Models that are received by the web component can be structured the same between all web components. This enables all web components to share the same code for handling messages from the server.

An event lifecycle can be utilized to define the steps that nearly always happen in a component. Defining the event lifecycle allows developers to make slight changes to the overall process of building a component without needing to reprogram the overall process. It also allows components to change or execute code when certain steps happen in a different component.

Many novel techniques can be used to simplify the process of creating web components within this framework. Features can be standardized and loaded into web components by developing a system that injects code into the component or appends code to the event lifecycle. Components that exist inside of other components can be standardized by utilizing a View-Model that is structured identically between components. Web components can refer to parts of the data using an alias and assign data from schema's queries to those aliases.

Additionally, this method can be used to develop interfaces which enable a more robust configuration of pre-built web components. Web components can be built that load inner components based on the defined schema. An interface herein referred to “component builder” can be developed to modify that schema in real time. This component builder can include of a title bar, editing pane, and a preview pane. This interface could allow the user to select one or more inner components that visually structure the data on the screen. Each of these inner components can be paired with a configuration component. When an inner component is displayed on the screen, the configuration component will be displayed in the editing pane of the component builder. When changes occur in a configuration component, those changes will be captured in a specific part of the pre-build web component's schema. As a result of changes to the pre-build web component's schema, the preview pane will refresh to reflect the component's current configuration.

In this system, defining the set of data to use with a component can utilize an interface to guide users through the process. The interface herein referred to as the query builder steps a user through the process of selecting a table, selecting columns, filtering out unwanted data and finalizing the query's options. When selecting a table, the user is presented with all of the tables alphabetically and can utilize search to quickly find the table they are looking for. After selecting a table, the user can select columns with a specialized dropdown. The columns on a table can be organized into two categories: relationships and primitives. In the specialized dropdown, primitives will display first, followed by relationships. Primitives can be selected as columns to include. Relationships can be expanded, and will show the related object's primitives and relationships below. A limit can be placed on the maximum depth of relationships. Primitives and relationships can be searched. Multiple search modes can be utilized to infer what an end user is searching for. Special search options can be selected to switch between search modes. To help the user filter out unwanted data, herein called building filters, we can reuse the specialized dropdown used in selecting columns. When building filters, the specialized dropdown will only allow the user to select one column. When there are no current filters, a button can indicate that a new filter can be added. Pressing this button will open the specialized dropdown and enable the user to select a column. As a result of selecting a column, a bar can show the selected column, a transitive verb dropdown, the type of operation, and between zero and two input fields. Filters can be grouped based on the conditional logic used to evaluate each filter. These groups of filters are herein called “filter groups”. When there are currently filters, an “AND” and “OR” button can show on the screen. Hovering over these buttons can indicate whether clicking the button will insert a filter into the current filter group, or create a new filter group. Creating a new filter group can populate it with the previously created filter and a new filter. Filter groups can indicate to the end user how they will evaluate by drawing one of two colored bars down the left side of filters and displaying the conditional logic at the top of each group. Filters can be draggable between groups and can be deleted. A filter group with no filters can be automatically removed from memory.

This method can include building web components that support the modularity of the system. These components can utilize the flexibility of the View-Model and schema, as well as techniques from feature standardization to load any inner components specified in the configuration. Additionally, the components can be previewed and configured inside of the component builder for user-friendly development.

Additionally, the component builder can allow users to create a copy of configured web components. The copy can include a duplicate of the underlying code used to create the component. The duplicate code would enable developers to make specific changes to a component without impacting previously configured web components or the underlying core system. The pre-build web components that are duplicated in this process can be developed to support common types of customization. The markup that defines how a web browser should display a component can accept changes to the markup in two or more ways. One way can be to replace all of the markup that defines one of the inner components. Another would be to accept markup as a control input and inject that markup into a specific portion of the component. If markup is accepted as a control input, the pre-built component can perform predefined computations on the markup.

It will be readily understood that the systems and components generally described herein and illustrated in the appended drawing figures could be arranged and described in a wide variety of different configurations. The following more detailed description of various embodiments, as represented in the figures, is not meant to limit the scope of this disclosure, but is merely representative of various embodiments.

The system and methods of the Application can be embodied in other specific forms without departing from its spirit or essential characteristics. The examples described are to be considered in all respects only as illustrative and not restrictive.

Reference throughout this description to features, advantages, or similar language does not imply that all of the features and advantages that can be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

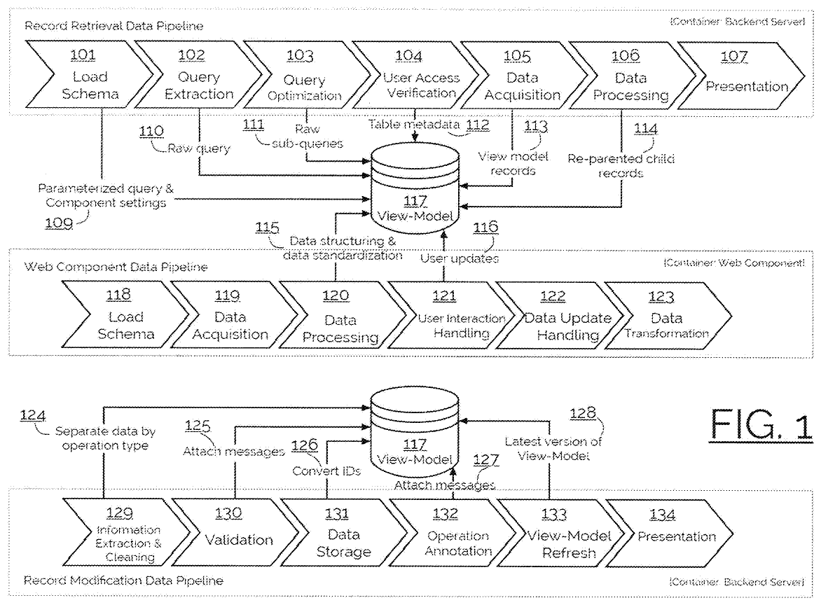

Examples related to specific implementation scenarios of the present disclosure are described in relation to FIG. 1 to FIG. 14. Configuring and reusing web components is described. The system of the present disclosure can be configured to inter-operate with any known or to-be-known software platforms. Such platforms include, for example, Salesforce™ SAP™, Microsoft Dynamics CRM™, and NetSuite™.

FIG. 1 is a drawing showing a diagram of a data pipeline to build a View-Model. As shown in FIG. 1, the backend server can include a data pipeline to build a View-Model. As used herein, “data pipeline” refers to a series of data processing steps, typically where each step delivers an output that is the input to the next step. The data pipeline for building a View-Model 117 or retrieving data in the illustrated example builds the View-Model 117 by adding or transforming data during each step of the process 101-107. The schema loading step 101 can be used to acquire a schema by its name in the system. For example, a table in the database can contain the JSON formatted schemas for building components. As used herein, JSON refers to an open standard file format and data interchange format used to store and transmit data objects. The schema loading step 101 can query that database to retrieve the schema, store a data representation of a query 109 in the View-Model 117 and/or store additional data 109 in View-Model 117. A query extraction step 102 can be utilized to convert the data representation of a query 109 into one more queries that can be consumed directly by a database management system. As used herein, “query” refers to a domain-specific language used to manage data held in a database management system. The query extraction step 102 can include the resulting query or queries 110 in the View-Model 117. The query optimization step 103 can be utilized when multiple queries will need to be run by the data acquisition step 105 in order to minimize the number of queries needed. For example, a data representation of a query 109 can request an initial set of data and another set of data loosely related to the initial set of data. In this example, without optimization, the relational database would need to run one query for the initial set of data, and an additional query for each record in that set of data. If the initial set of data contained 1,000 records, that would result in 1,001 queries. Query optimization 103 can be used to reduce the number of queries required in this example to two or three. This optimization can transform the data representation of the query 109 with information about the optimizations. A user access verification step 104 can cross reference the current session's user against the tables, columns and rows a user has permission to access. As used herein, “session” refers to the mechanism for managing the identity of an end-user and for differentiating between end-users. While doing this, the user access verification step 104 can store the table's column metadata 112 in the View-Model 117. As used herein, “metadata” refers to data that describes other data, such as the type of data or values that can be stored in the column. The data acquisition step 105 can be utilized to retrieve the data from the database management system. This data 113, as herein referred to as “records,” can be stored in the View-Model 117. The data processing step 106 can be utilized to prepare data for consumption by the web component. An example of this data preparation can include restructuring the data after query optimization 103 so as to make clear how records from a loosely related set of data are related to an initial set of records 114. A presentation step 107 can be utilized to compress, strip unnecessary data from, and/or reformat the View-Model according to the web component's specification.

Additionally, as illustrated in FIG. 1, a web component can include a data pipeline 118-123 to acquire the View-Model 117 from the backend and transform its data. The web component's load schema step 118 can send a request into the backend for a schema based on the web component's configured schema name. A schema can also be specified inside of the component's configuration, which allows the component's data pipeline to skip the load schema step 101, 118 and begin from the data acquisition step 119. The data acquisition step 119 can send a request into the backend containing the component's current View-Model 117 in order to update the View-Model's data. This network request can execute the backend data pipeline process for building and transforming a View-Model 102-107. A View-Model 117 returned from the backend server can begin the web component's data processing step 120, which can be seen as a part of the standardization layer 306. The component's data processing step 120 can transform the data in the View-Model 117 for consumption by the component. For example, records that contain table columns that are being referred to by an alias 205, 206, 211 can have a transformation 115 applied that allows the component to refer to those columns by the alias. The data processing step 120 can also standardize how messages from the backend are handled by the component. For example, a request that results in an error can cause a toast message to appear in the component 411. Events in the component can result in a user interaction handling step 121 to occur, in which the data contained in the View-Model 117 is updated 116. A data update handling step 122 can be used to indicate to the component that the data in the View-Model 117 should be synchronized with the data in the backend database. A data transformation step 123 can be used to transform 126 the component's View-Model 117 so that it can be used by a backend data pipeline. For example, aliased columns 205, 206, 211 that were transformed 115 can be transformed again so as to be referenceable via the database's column name.

FIG. 1 also illustrates an additional backend data pipeline 129-134 that can be used to create, update or delete data from the database. In this data pipeline, an information extraction and cleaning step 129 can separate records in the View-Model 117 based on whether the server is creating, updating, deleting or ignoring the record 124. A validation step can be used to verify that the session's user has permission to create, update and/or delete records contained in the View-Model 117. If a validation step is failed, informative messages 125 can be added to the View-Model 117 and the data pipeline can jump straight to the presentation step 134. The data storage step 131 can be used to perform the transformations to the database as identified during the information extraction and cleaning phase 129. The data storage step 131 can also convert temporary IDs to the concrete IDs used by the database 126 after creating records. An operation annotation step 132 can be used to attach messages 127 to the View-Model 117 based on the results of the data storage step 131. For example, if a user attempts to create a record and the record is missing data in a required column, a message 127 can be attached informing the user that the column's data must be set. A view model refresh step 113 can interpret whether the system or View-Model 117 has specified that the current View-Model 117 should be run through the record retrieval data pipeline 102-107. The presentation step 134 can be responsible for returning the View-Model to the web component in a format that it can consume. It can be identical to the presentation step in the record retrieval data pipeline 107.

Different systems on the same platform will often run into the same common problems. For example, two systems can both need to model a many-to-many relationship. The term “many-to-many relationship,” as used herein, refers to a database architectural feature where multiple records in one table are related to multiple records in another table. In current software platforms, there are a limited number of ways for an end user to define which records are related in a many-to-many relationship. A web component can improved the user experience when defining many-to-many relationships, in most cases that web component would not work in both systems without being reworked. Defining a schema 101 and aliases for the required fields 205, 206, 211 allows a web component developer to abstract the exact names used in a backend database from the values used by a web component.

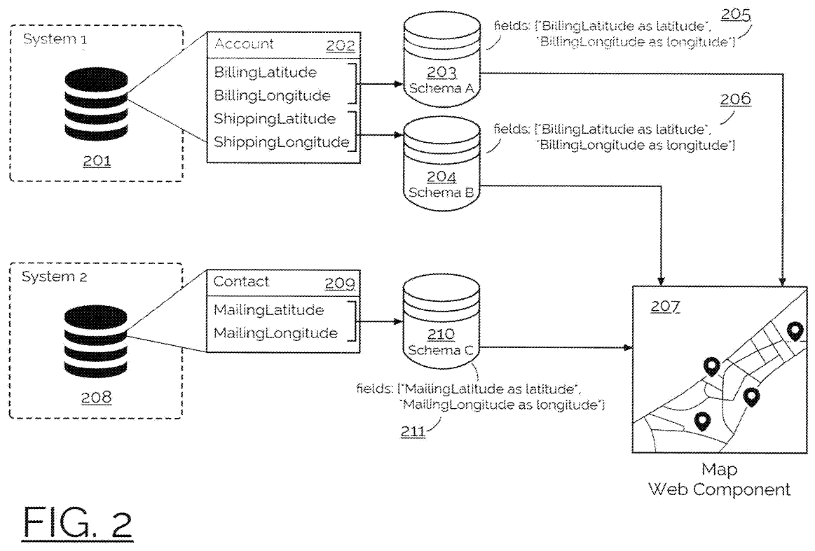

FIG. 2 is a drawing showing an exemplary web component which uses latitude and longitude coordinates to draw markers on a map. As illustrated in FIG. 2, a single web component 207 can be used in different systems 201, 208 and use different underlying tables and columns 202, 209. This is done by defining a schema 203, 204, 210 for web component 207 and using aliasing 205, 206, 211 to abstract the table and column 202, 209 names away from the web component 207 specification. In this exemplary illustration, a web component 207 relies on latitude and longitude coordinates to draw markers on a map. An example account table 202 contains two sets of latitude and longitude coordinates—one for an account's billing address and one for an account's shipping address. By defining a schema 203 for the billing coordinates and a schema 204 for the shipping coordinates, the same web component 207 can be used for displaying both billing address coordinates and shipping address coordinates.

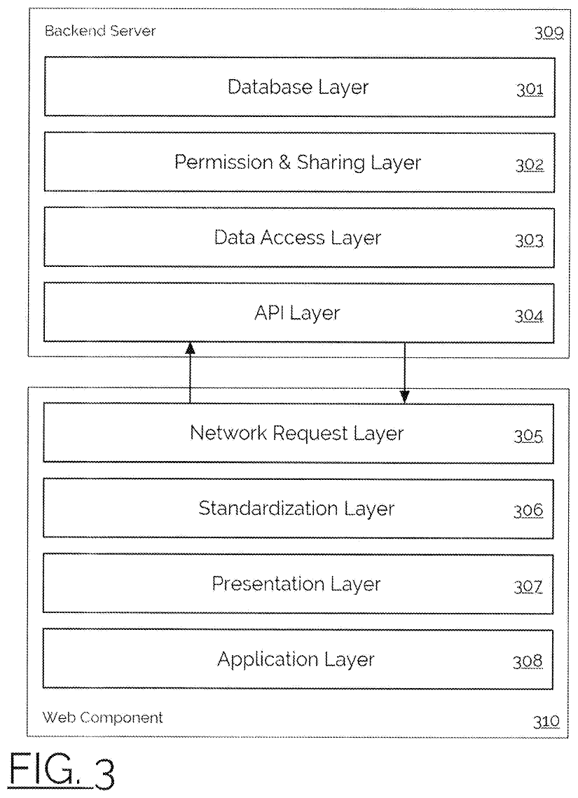

FIG. 3 is a drawing showing a diagram of an exemplary organization of a web component. FIG. 3 depicts a sample of how a backend server 309 and a web component 310 can be organized into 8 layers 301-308. The database layer 301 can house the data storage for the system. A permission and sharing layer 302 can verify that requests into the database follow the current session's user's permissions. The data access layer 303 can translate a data representation of a query into one or more queries and uses those queries to build the View-Model. The API layer 304 can provide web components with services like record retrieval and modification. The network request layer 305 can be responsible for sending and receiving messages to the backend server and handling network-related errors. The standardization layer 306 can be responsible for preparing incoming View-Models for the web component, preparing outgoing View-Models for the backend server and handling certain properties in the View-Model systematically across all relevant web components. The presentation layer 307 can perform additional transformations to a View-Model. Two examples of those additional transformations include formatting dates that come in from the server to a human-readable variant and calculating the sum on a numerical field for display in the component. The application layer 308 can include, but is not limited to, all of the user interaction, event handling and user interface code.

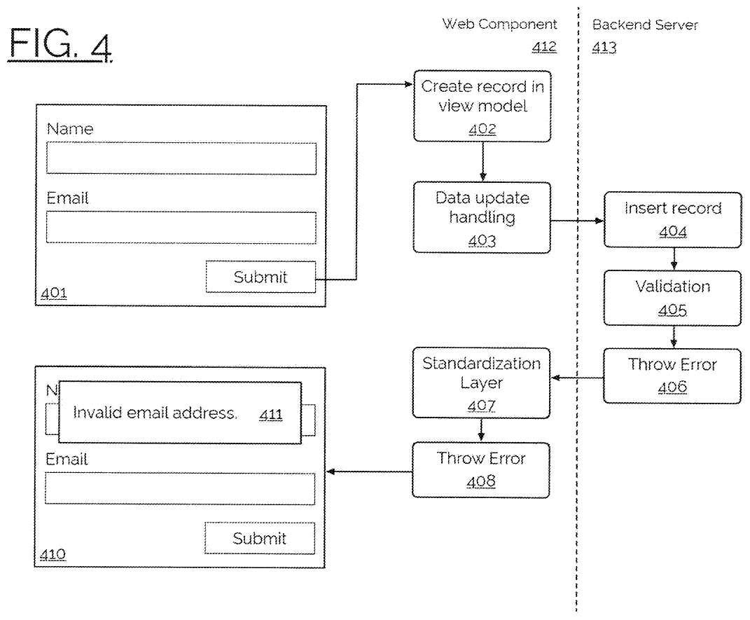

FIG. 4 is a drawing showing an exemplary standardized web component and backend server. An example of how a web component and backend server can standardize certain behaviors is illustrated in FIG. 4. A form displayed inside of a web component 401 is submitted by an end user. This causes a record to be created in the View-Model 402. In this example, that newly created record is immediately sent to the backend server for synchronization 403. The backend server will attempt to insert the record into the database 404. Validation methods will check the validity of the record 405 and will throw an error 406 when it is determined that the record is missing data. The View-Model will be returned to the web component with details of this failure. The web component's standardization layer 407 will detect that an error was thrown by the backend server and will throw an error in the component 408. The original form 410 will display a toast message 411 with details about the error that occurred.

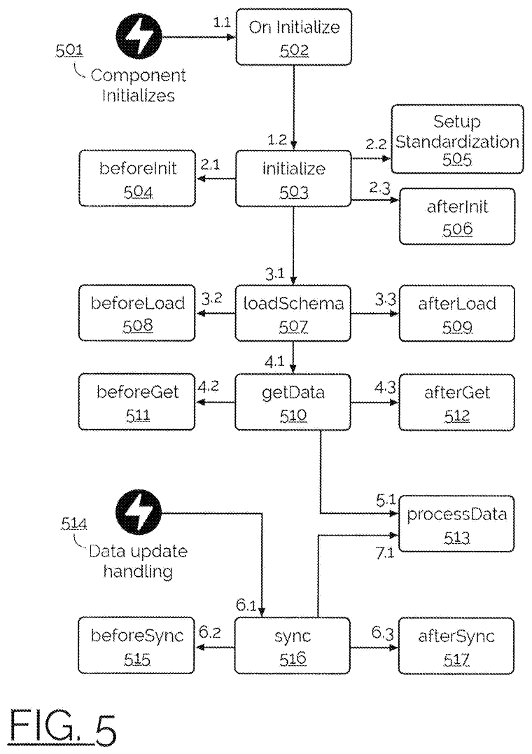

FIG. 5 is a drawing showing an exemplary event lifecycle. Web components built using these methods can incorporate a data pipeline similar to the one illustrated in FIG. 1 118-123. To interface with and customize how the data pipeline transforms data, an event lifecycle similar to FIG. 5 can be incorporated. Such events include, but are not limited to, initialization 503, schema loading 507, data retrieval 510, and view model syncing 516. To simplify the process of interfacing with and customizing a web component's data pipeline, we can include a before and after method for each event 504, 506, 508, 509, 511, 512, 515, 517. The before and after methods can be overwritten or new blocks of code can be designated to run in conjunction with any of these methods.

When a component initializes 501, a method can be defined to kick off the initialization process 502. When the initialization process runs 503, the first thing it can do is run the before initialization process 504. The before initialization process gives the component an opportunity to set up any data structures related to tracking statuses in a component. For example, a component can want to track if it is currently loading a schema, loading data, syncing data, or if it is ready to display data to the user. Setting this up during the before initialization process enables the component to immediately reflect to the user that it has not yet loaded the schema or data. During initialization 503, the component can set up the standardization process 505. The standardization process can designate several blocks of code to hook into various before and after methods. As used herein, to “hook” into a method refers to a metaprogramming process that systematically makes new sections of the program execute whenever certain pre-established sections of the program execute. Examples of code that would be hooked into the event lifecycle during the standardization layer setup 505 include transforming aliases 205, 206, 211 after receiving data 512, 517 and checking for messages 407, 408 after receiving data. After setting up standardization 505, a post-initialization process 506 can run.

After initialization has completed, the schema loading process 507 of the event lifecycle can begin. The before load schema process 508 can be executed before the body of the schema loading process. This method provides the developer an opportunity to hard-code a component's schema into the component or change the way in which the schema will be loaded. During the schema loading process 507, the component can make a call out to the backend process to retrieve a schema by name Once a component has schema, the component can run the after load schema process 509. This method can automatically process information in the schema. For example, a schema can contain placeholders that need to be replaced with real values during a component's runtime.

After the schema has been loaded and processed, the web component can begin the data loading process 510. The data loading process 510 can first call the before data loading process 511 before it makes a call out to the backend server. The before data loading process 511 can run temporary transformations on the View-Model per the standardization layer 306 and can cause the component to indicate that it is currently loading data. During the data loading process 510 a callout can be sent to the backend with the component's current View-Model. After the backend server returns a View-Model 107, the after data loading process 512 can run. The after data loading process 512 can be utilized to transform the returned View-Model per the standardization layer 306 before merging it with the current component's view model. Once the View-Model has been processed, the data processing process 513 can be executed in order to format the data in such a way that the web component can display it 307.

When the user interacts with the component, data in the View-Model can change. User interaction can require the component to synchronize data 514. The scope of synchronizing data can include creating records, updating the values in existing records, deleting records and getting changes to the database as a result of aforementioned actions. During the synchronization process 516, the before synchronization process 515 can be executed first. Similar to the before data loading process 511, this process can be utilized to temporarily transform the View-Model per the standardization layer 306. It can also validate, sanitize and transform user input in the View-Model. Once the View-Model is ready to be sent into the server, a network callout can be sent into the record modification data pipeline 129-134. The server's response can be processed by the after synchronization process 517 as per the standardization layer 306. Once the View-Model has been processed, the data processing process 513 can be executed again in order to ensure the formatting in the View-Model matches the requirements of the web component.

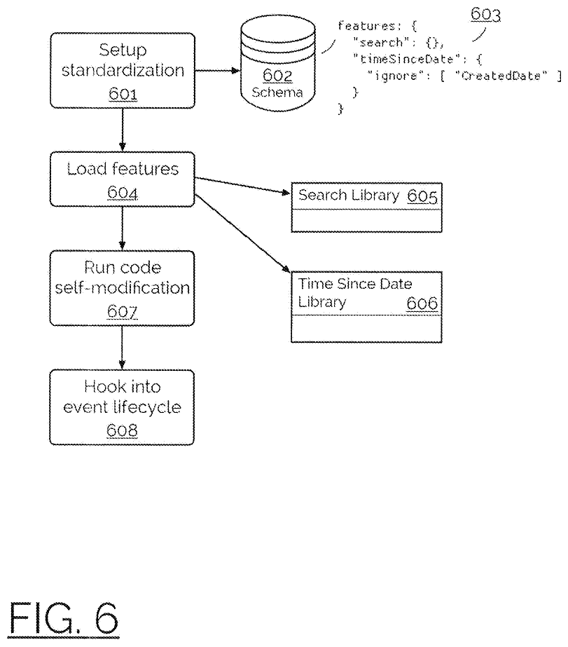

FIG. 6 is a drawing showing an exemplary schema of a web component. A web component's schema can specify features to load into the component at runtime as illustrated in FIG. 6. As used herein, “features” refer to libraries that are responsible for enabling a specific functionality in the component. Examples of features used in FIG. 6 are a search library 605 and a date formatting library 606. In the illustrated example, the search library 605 would overwrite the default search function built into the base web component 1408 with a search function capable of performing approximate string matching. This search library uses more memory in the client's browser and is not needed by all web components. For this reason, we only load the search library where it is needed during a component's initialization. In the illustrated example, the date formatting library 606 can be used to automatically reformat any dates in the View-Model with something more human readable. During the setup standardization 601, 505 code can hook into the after schema load process 509 to check the schema 602 for feature load requests. The schema JSON can contain an object that describes each of the features to be loaded into the component 603. Those feature definitions can contain parameters to pass to the feature. If there are features to load, we can run a block of code for loading the features into memory 604. With each of the features we load 605, 606, we can run self-modifying code 607 in order to overwrite existing methods and to make new methods available for the component. For example, the search library 605 can overwrite the default search method with a new method that it defines and it can add several methods to the component for enabling greater configuration by developers. Features can then hook into the event lifecycle 608 in order to automatically modify the behavior of the component's data pipeline. For example, the date formatting library 606 can hook into the after data loading process 512 and the after data synchronization process 517 in order to add human readable dates to each of the records in the View-Model.

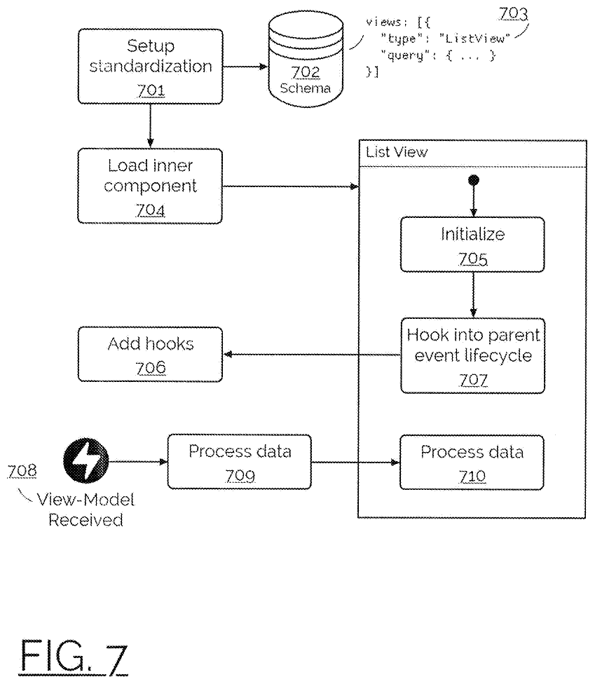

FIG. 7 is a drawing showing how a component can load an inner component. Some components can utilize a method similar to how we load features in order to dynamically load inner components. As used herein, “inner components” refer to components that are displayed inside of another component. In FIG. 7, an example is illustrated describing how a component can load an inner component named List View. While setting up standardization 701, the component can hook into the after schema load process 509 to check the schema 702 for inner component definitions. The schema JSON can contain a list of objects that describe one or more inner components to load 703. The outer component can then load one of the inner components into memory 704. The inner component can run initialization code 705 in order to build its own data pipeline. Then, the inner component can hook into the outer component's event lifecycle 706, 707. After the View-Model is received and processed 708 and the outer component has run its data processing code 709, 513, the inner component can receive the updated View-Model. From there it can run a data processing step 710 of its own in order to prepare the data for presentation to the user.

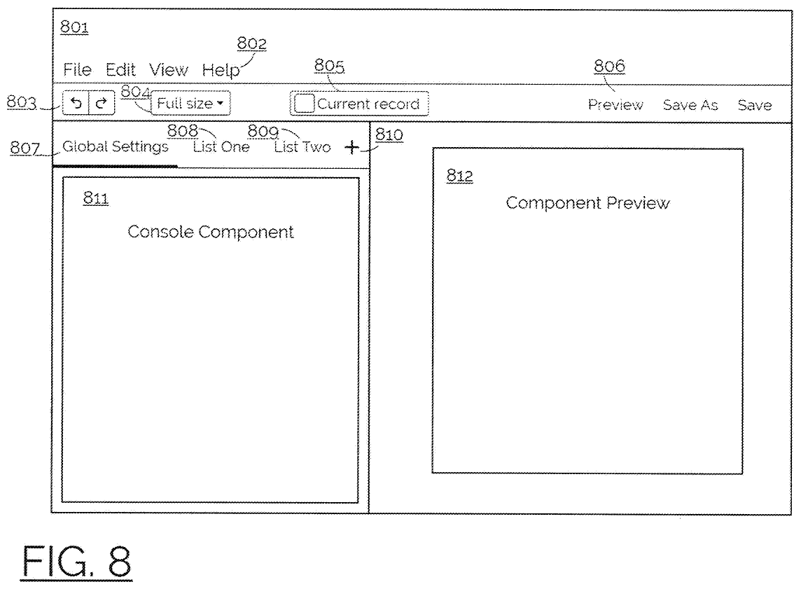

FIG. 8 is a drawing illustrating an exemplary application for building components. Using the foundations established for developing web components, we can begin to describe how pre-built components can be configured by system administrators. FIG. 8 illustrates an example of an application for building components. The application can have a header 801 with a file menu 802 so end users can have a user experience similar to many desktop applications. The file menu 802 can help communicate to the user that they are able to work with component configurations in the same way as desktop applications that open and edit files. Usability features like undoing and redoing 803 actions can be included in this component-building application. The width at which end users will view the configured component will depend heavily on where the component is placed. For example, components can be used in the primary column of a two column layout, the sidebar, or as a standalone application. A preview width dropdown 804 can be included to automatically resize the component preview 812. Configured components can require that they are added to a web page that displays a single record. For example, a system with a contact database table and an account database table can define a relationship such that each contact is related to an account and each account can have multiple related contacts. If a system administrator was building a web component that displays all of the contacts related to an account, that component can only work when displayed on a page that specifies one and only one account. To simulate this behavior, the component building application can allow the system administrator to specify an example record 805. The component building application can also display buttons that enable a system administrator to quickly save and preview their work 806. In the illustrated example, we show three tabs. One tab for global settings 807 and two tabs to illustrate inner components that can be configured and displayed 808, 809. On the far right of the tab bar is a plus button 810 that can be used to add additional inner components to the component being configured. The plus button 810 can show a list of potential inner components, and add a new tab to the tab bar if one is selected. A console component system 811 can be used to enable configuration of the schema. For example, in the global settings tab the system administrator would be able to configure settings that apply to all views. For each inner component tab, a console component specific to the inner component's type can be displayed to enable specific configuration of that inner component. As the schema is configured in the console components 811, the new schema can be sent to the component preview 812 to display the updates.

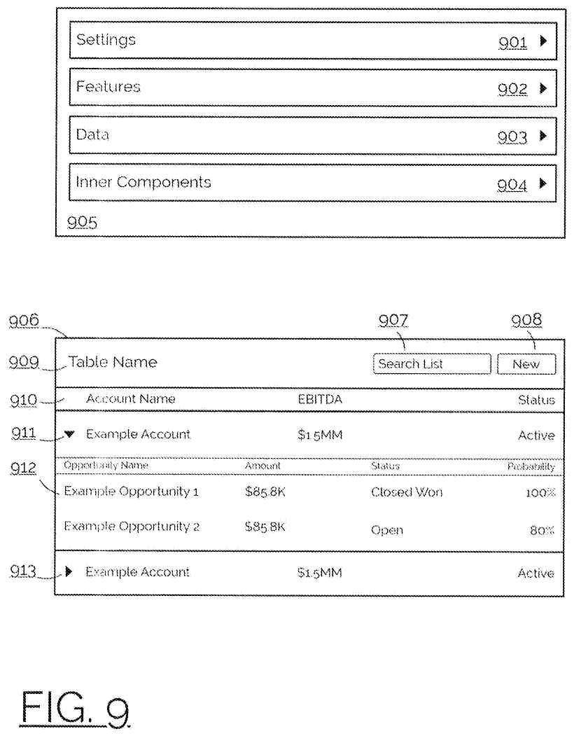

FIG. 9 is a drawing showing an exemplary Table Component and a console component that can configure it. To enable a high level of configuration on the components that are configured in the component builder, components can have complimentary console components. A console component can be used by a system administrator to create a component-specific schema. In FIG. 9, an illustrated example shows a Table Component 906-913 and a console component 901-906 that can configure it. The console component 901-906 can be contained in the console component section 811 of the component builder. In the console component, we illustrate 4 possible sections. Each section can be expanded to reveal configuration for a specific aspect of the component. In the settings section 901, the console can enable a system administrator to modify the table name 909, enable search 907 or display a “New” button 908. In the features section 902, the console can enable a system administrator to make the search feature 907 accept non-exact matches, specify which columns can be searched or apply a data formatting transformation to all currency fields. The data section 903 can enable a system administrator to build a record retrieval query for the component. The inner components section 904 can be used in components that support embedding components. In the illustrated example, Account records 911, 913 can be expanded to show a table of opportunities 912 associated with the expanded account record. The inner components section 904 in this example would be used to assign a table component as an inner component. The inner table component can have its own console component used to configure the details of the inner component.

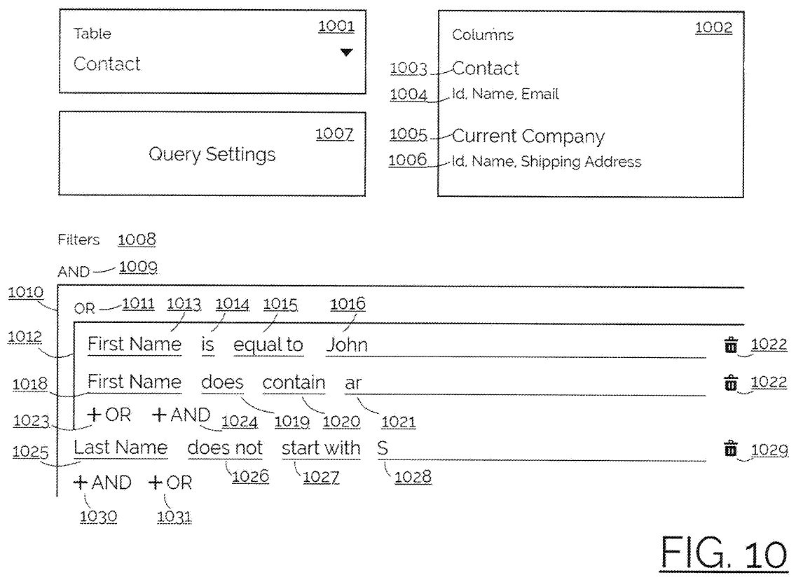

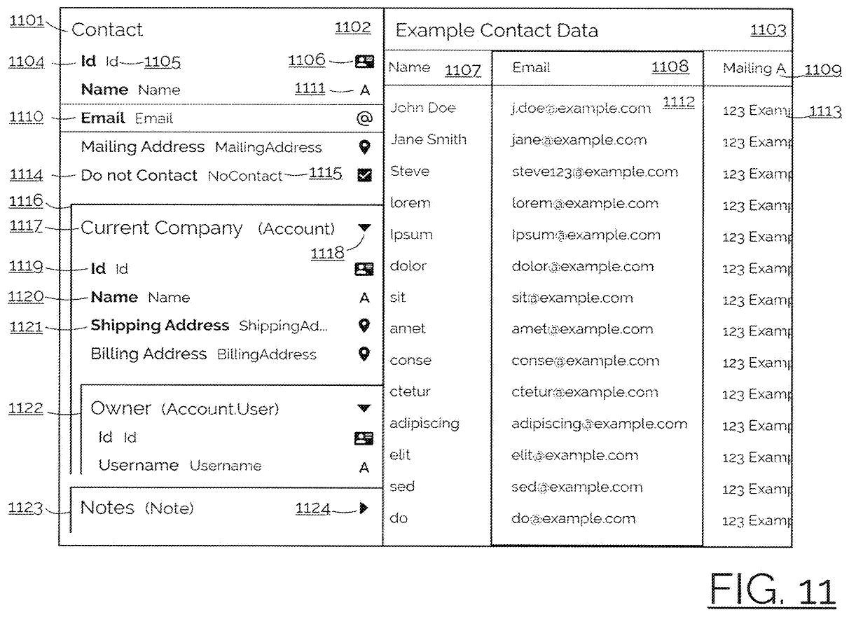

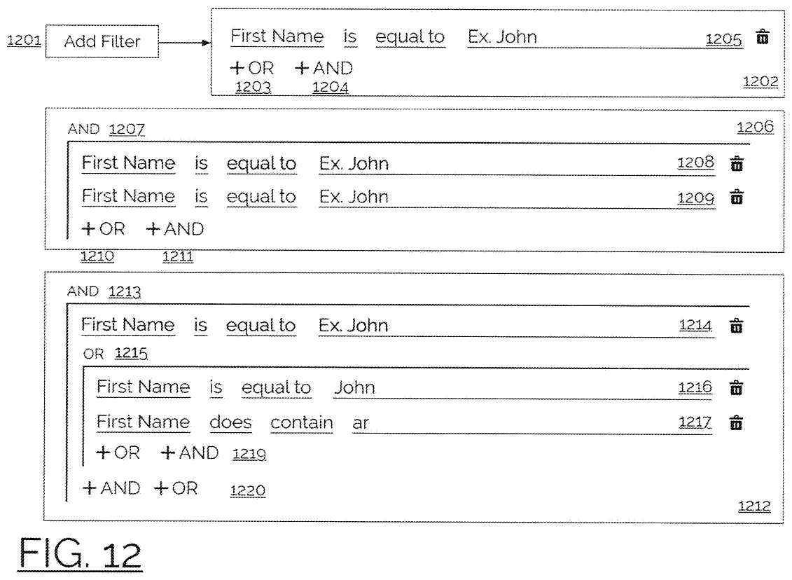

FIG. 10 is a drawing showing an exemplary query builder. Setting the data for the component can pose a challenge for system administrators without knowledge of querying languages like SQL. FIG. 10, FIG. 11 and FIG. 12 contain illustrated examples of a tool meant to assist with the configuration of data in components. FIG. 10 illustrates features a query builder can present to a user to assist with the configuration of data. As used herein, “query builder” refers to a software component, utility or tool used to build a data query or similar data retrieval mechanism. The query builder can display any combination of a table selection 1001, column selection 1002, query settings 1007, and filters 1008. The column selection display 1002 can display the selected columns 1004, 1006 underneath the data source 1003, 1005. In the illustrated example, the query builder is selecting the Id, Name and Email fields 1004 from the contact table 1003. Displayed underneath that, the Id, Name and Shipping Address fields 1006 are selected from the account record designated as a contact's current company 1005. The filter display 1008 can be used to define criteria for selecting records. In the illustrated example, the filter criteria will select all contacts where the first name is John or the first name contains the letters ‘ar’ and the last name does not start with the letter ‘s’. I.e. contacts named John Doe and Arther Jones would be retrieved, but John Smith and Jane Doe would not. A filter can be composed of one or more criteria. A criteria 1013-1016, 1018-1021, 1025-1028 can contain any combination of: a field 1013, 1018, 1025, a logical operation 1015, 1020, 1027, a transitive verb that can be negated 1012, 1017, 1024 and one or more user input fields 1016, 1021, 1028 when the selected logical operation requires user input. Criteria are designed such that reading the inputs from left to right can yield a grammatically correct and logically coherent sentence. For example, “First name is equal to John” can be read from the inputs on the first criteria 1013-1016 and is a logically coherent statement. To accomplish this, the transitive verb can be switched from “is” 1012 to “does” 1017 to maintain conventional grammar rules. Criteria can be grouped by the type of evaluation to run on each group. In the illustrated example, if criteria one 1013-1016 or criteria two 1018-1021 evaluate to true and if criteria three 1025-1028 evaluates to true, then the record in being evaluated matches the criteria. These three criteria can be partitioned into two groups. Group one evaluates if criteria one or criteria two are true. Group two evaluates if group one and criteria three are true. Group one uses the logical operation of “OR” between each of the criteria, meaning that if any of the criteria in the group are true, the group evaluates to true. Group two uses the logical operation of “AND” between each of the criteria, meaning that if any of the criteria in the group are false, the group evaluates to false. The filter display 1008 can indicate how groups are structured using lines along the criteria. Group one contains criteria one and two, so it displays a vertical and horizontal line 1012 around criteria one 1013-1016 and two 1018-1021. Group two contains group one and criteria three, so it displays a vertical and horizontal line 1010 around group one and criteria three 1025-1028. Group one performs an “OR” operation between criteria, so it displays “OR” 1011 above the lines that indicate the group 1012. Group two performs an “AND” operation between criteria, so it displays “AND” 1009 above the lines that indicate the group 1010. Buttons to add new criteria can show in each group 1023, 1024, 1030, 1031. When the user clicks the button that matches the group operation 1023, 1030, a new criteria can be added to the group. When the user clicks the button that does not match the group operation 1024, 1031 a new group can be created that contains

FIG. 11 is a drawing showing an exemplary column selection tool. Both the column selection 1002 and the fields in criteria 1013, 1018, 1025 can require an end user to select columns from a table. A non-technical system administrator can require help understanding the underlying structure of a table and how tables relate to each-other. Illustrated in FIG. 11 is an example of what a column selection tool can look like. In one section can be displayed a list of columns under the current table and a list of relationships to other tables 1102. If the column selection tool can be used to select multiple columns, like the for the column selection 1002 component in the query builder, selected columns can be brought to the top of their section. For example, Id, Name and Email 1104, 1110 are bolded and brought to the top of their list. The type of data in a column can be indicated with an icon 1106, 1111. If columns in a database can have an API name that is different from the human readable label, the tool can display both the API name 1104, 1114 and the label for a column 1105, 1115. The column selection tool can allow users to select columns from tables that are related together. To do this, the column selection tool can have expandable sections for each relationship 1117, 1122, 1123. The column selection tool can use a horizontal and vertical line to indicate which relationship belongs to which table 1116, 1122, 1123. In the illustrated example, the contact table has a current company relationship to the account table 1117. The account table has an owner relationship to the user table 1122. When looking at fields under the user table, the end user can see that the user table is two degrees of separation away from the original record. The contact table also has a note relationship that belongs to the note table 1123. In this illustrated example, the end user can look at the left side of the note section and count the number of vertical lines to know that the notes section is related to the contact table and not the account or user table. Selected columns under a relationship can be bold and listed at the top of a relationship section 1119-1121 in the same way as under the primary table 1104, 1110. A caret, chevron or similar icon can be used to indicate if a section has been expanded 1118 or is contracted 1124. Examples of real data in the database 1112, 1113 can be displayed to help an end user decide which columns to select. A table of example data 1103 can be displayed for that reason. The headers going along the table 1107-1109 can follow the order of columns displayed in the main section 1102. When hovering over a column, the column in the main section 1110 and the corresponding row in the table of example data 1108 can both indicate that they are highlighted. Hitting enter or clicking either highlighted section can select the column or toggle the column's selected state.

FIG. 12 is a drawing showing an exemplary filtering criteria. The process of creating the correct set of filters can have a potentially high learning curve for new users. The query builder can use steps similar to the illustration in FIG. 12 to walk users through the process of setting filtering criteria. A new query can not have any criteria set initially. In this case, the user can be presented with a simple button for adding the first criteria 1201. After pressing the “Add Filter” button 1201, the user can be presented with a criteria they edit 1202. In addition to the criteria 1205, the user can be presented with buttons for adding additional criteria 1203, 1204. When there is only one criteria in a set of filters, the User Interface can not show any indication of groups. While there is only one criteria, if a user clicks one of the buttons for adding additional criteria 1203, 1204, two criteria 1208, 1209 can show with group markings surrounding the criteria 1206. If the user had clicked the ‘AND’ button 1204, the group would have markings indicating that it is an ‘AND’ logical operation 1207. If the user had clicked the ‘OR’ button 1203, the group markings would indicate that it is an ‘OR’ logical operation. When there are two or more criteria and the user hovers over one of the logical operation buttons 1210, 1211, the User Interface can indicate how the new criteria will be added. If the logical operation on the button matches the operation in the group 1211, 1207, then the User Interface can indicate that new criteria will be inserted at the bottom. If the logical operation on the button does not match the operation in the group 1210, 1207, then the User Interface can indicate that a new group will be created containing the previously added criteria and the newly created criteria. For example, if the end user were to click the ‘OR’ button 1210 for the illustrated example 1206, a new group would be created 1215, 1212. The first criteria 1208 can remain in the outer ‘AND’ group 1213, 1214. The second criteria 1209 can be moved into the new ‘OR’ group 1215, 1216. The new criteria 1217 can also be inserted into the new ‘OR’ group 1215. Each group can have their own set of buttons for adding criteria 1219, 1220. Criteria can be dragged and dropped between groups to adjust which logical operations run and how the filter is evaluated.

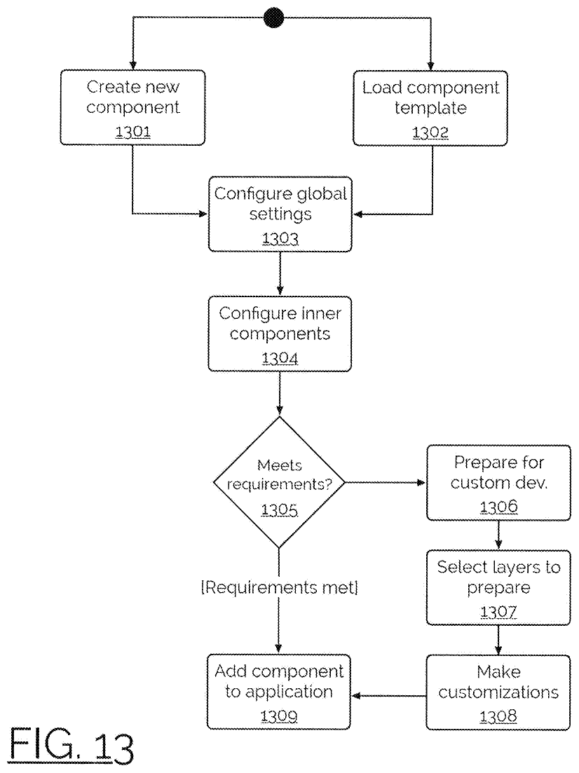

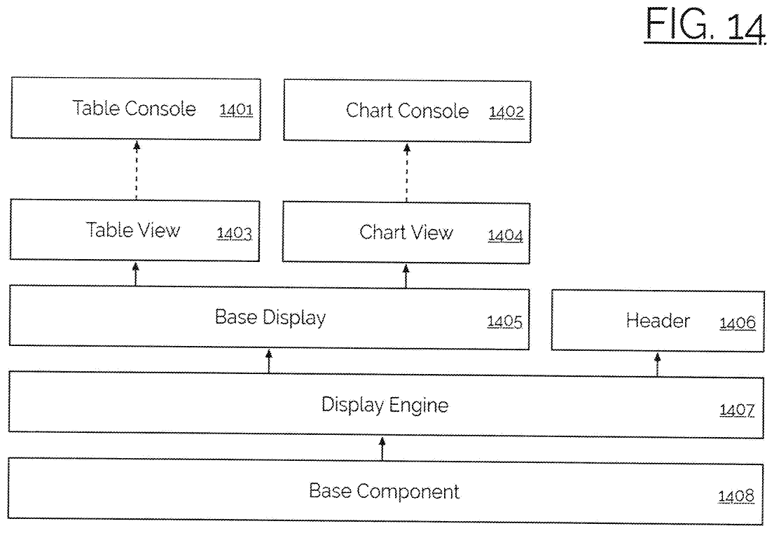

FIG. 13 is a flow chart showing steps of an exemplary user experience. The opportunity to create a unique user experience is possible with the aforementioned advancements to how components are configured. An example of what such a user experience could look like is illustrated in FIG. 13. When first opening a component builder, the user can be able to start creating a new component 1301 or loading a component from a template 1302. Loading a component from a template 1302 can create an instance of a component that is preconfigured for solving common problems, which can enable the end user to reconfigure it to solve a specific problem. Whether the user is loading a component from a template 1302 or creating a new blank component 1301, the user can be presented with the ability to configure the global settings of the component 1303. The component builder can provide an interface for configuring the inner components of the component being built 1304, 808, 809. After all configuration is complete, the end user can analyze if the component meets all of the original requirements 1305. If it does not, the component can be prepared for custom development 1306. Preparing for custom development can have an end goal of creating source code for a component that can be edited without impacting other components. During the process, the user can select the modules 1307 of a component to make editable. FIG. 14 provides an illustrated example of the modules of a component that can be exported when preparing for custom development. An example of selecting the modules to make editable 1307 might be exporting the Table View 1403, the Base Display 1405 and the Display Engine 1407 while excluding the other modules. After exporting those three modules, a developer would be able to make customizations to those parts of the custom component 1308 without impacting other components that utilize the Table View 1403, Base Display 1405 or Display Engine 1407. As used herein, “custom component” refers to a component that is developed by exporting code from the prepare for custom development 1306 process. By limiting the export to only those three modules, future updates to modules like the Base Component 1408 will automatically be included in the custom component. Once a component meets the needs of the system, it can be added to the application 1309.

FIG. 14 is a drawing showing exemplary modules and dependencies of a configured component. The illustration in FIG. 14 depicts an example of the modules and dependencies of a configured component. In the illustrated example, a Display Engine 1407 has been configured to display a Table View 1403 and a Chart View 1404. The Display Engine 1407 extends a Base Component 1408 to inherit the common libraries used in building a Network Request Layer 305, a Standardization Layer 306, and an event lifecycle 503-517. The Display Engine 1407 utilizes a Base Display component 1405 to establish standards that developers can follow when building inner components like the Table View 1403 and the Chart View 1404. A Header component 1406 is also utilized to standardize how the top section of components are configured in the schema and how they are displayed to users. Each of the views used by this component 1403-1404 have corresponding console components 1401-1402. The Console components can be displayed in the component builder's console component section 811 to guide an end user through the configuration process.

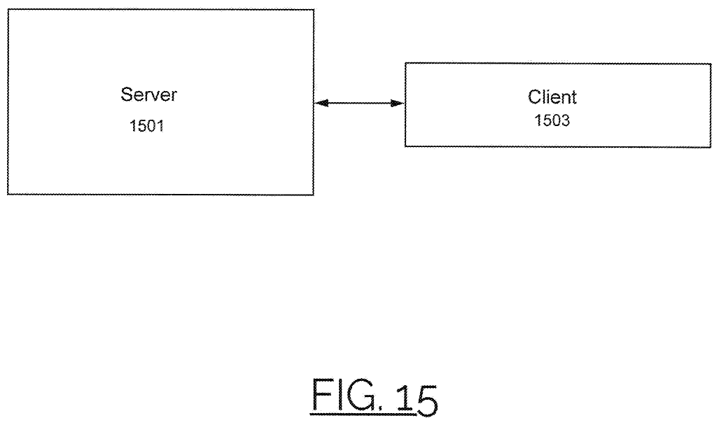

FIG. 15 is a drawing showing an exemplary server 1501 and client 1503 suitable to run a system and method of a modular framework for configuration and reuse of web components according the Application. Any suitable computers can be used to provide server 1501 and client 1503.

In summary, the Application describes a framework and method for building web components that can be reused in systems with the same underlying software and can be driven by configuration files. The new method can include developing a backend system for translating an incoming configuration message into a View-Model, developing a backend system for interpreting configuration data in order to retrieve data, developing extendible interfaces for standardizing all communication with the backend system, defining an event lifecycle that can be extended by web components, defining techniques for building within this web framework, developing interfaces for configuring components, developing interfaces for configuring data requests, developing web components for supporting the modularity of a system and allowing web developers to extend the functionality of a pre-built component.

The system and methods of the Application including View-Models and schemas can be provided on a computer readable non-transitory storage medium as non-transitory data storage. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, can be combined into many other different systems or applications. Various presently unforeseen or unanticipated alternatives, modifications, variations, or improvements therein can be subsequently made by those skilled in the art which are also intended to be encompassed by the following claims.

What is claimed is:

1. A method for passing a View-Model from a backend system to a frontend system, comprising:
providing a schema that comprises information for building one or more queries;
verifying a user access against requested queries;
acquiring data from the requested queries; and
processing data of a plurality of returned records.

2. The method of claim 1, wherein the schema is referenced by a shorthand name loaded into a record retrieval data pipeline.

3. The method of claim 2, wherein a parameterized query comprises subqueries and the record retrieval data pipeline optimizes the queries to run, and the processing data includes reparenting a plurality of results of the subqueries.

4. The method of claim 1, wherein the schema comprises multiple queries that are run during the step of acquiring the data.

5. A system for standardizing how data is received and processed by a component comprising:
a decouple components process to decouple from database specifications;
a define repeatable transformations on data models process;
a dynamic inject code process to dynamically inject code into the component; and
a repeat user interface process to repeat behaviors across the system.

6. The system of claim 5, wherein the component is independent of database specifications and coupled to database records through a schema or equivalent data structure.

7. The system of claim 6, wherein the schema or an equivalent data structure defines parameters of a data transformation which causes repeatable transformations to occur on specified columns of a View Model.

8. The system of claim 7, wherein a component load code from a library executes a self-modifying code.

9. The system of claim 7, further comprising an automatic display of messages that appear in the View Model on a user display.

10. A method for passing a View-Model from a backend system to a frontend system, comprising:
providing a schema that comprises information to build one or more queries;
verifying a user access against requested queries;
acquiring data from the requested queries;
processing data of a plurality of returned records; and
wherein a data pipeline in web components comprises the steps of:
loading schema data about the web components;
acquiring the data from a backend server; and
processing retrieved data.

11. The method of claim 10, further comprising a system for standardizing how the data is received and processed by a component comprising:
a decouple components process to decouple from database specifications;
a define repeatable transformations on data models process;
a dynamic inject code process to dynamically inject code into the component; and
a repeat user interface process to repeat behaviors across the system.

12. The method of claim 10, further comprising transforming the data that comes in from the backend server.

13. The method of claim 10, further comprising transforming the data in the View-Model before sending it to the backend server.

14. The method of claim 10, further comprising running extendable methods before and after each process.

15. The method of claim 14, further comprising a system to append code to the extendable methods.

16. The method of claim 15, further comprising the step of defining and executing code of related, dependent, or child components to append a code to the extendable methods.

17. A method for storing changes to database records comprising:
generating a View-Model sent to a component;
performing component process transformations of the database records in the View-Model;
sending the View-Model from the component into a backend server; and
recording the backend server records data to a database.

18. The method of claim 17, wherein information about operations attempted by the backend server is stored in the View-Model.

19. The method of claim 17, further comprising the steps of:
providing a schema that comprises information to build one or more queries;
verifying a user access against requested queries;
acquiring data from the requested queries; and
processing the data to synchronize the data in the View-Model with the database.
